(19) United States
(12) Patent Application Publication
(10) Pub. No.: US 2015/0000508 A1
(43) Pub. Date: Jan. 1, 2015

(54) Pole Position Sliding Pickup System

(71) Applicant: Michael John Canavan, Bethel, CT (US)

(72) Inventor: Michael John Canavan, Bethel, CT (US)

(21) Appl. No.: 13/932,303

(22) Filed: Jul. 1, 2013

(51) Int. Cl. G10H 3/12

(52) U.S. Cl. CPC G10H 3/12; G10H 2220/465
USPC 84/743

(57) ABSTRACT

The Pole Position Sliding Pickup System changes the way tonal variety is arrived at by electric guitar players. Rather than installing multiple pickups in different positions in order to achieve a limited variety in tone, the Pole Position Sliding Pickup System uses a single pickup which can be moved quickly and easily to any position between the base of the neck and the bridge in order to achieve a much greater variety in tone. Not only are the variety of possible tones increased, but so is the ease with which they can be attained, because the method of sliding the pickup into place is easier than conventional methods of choosing stationary pickups.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

The Pole Position Sliding Pickup System is relevant to the field of musical instruments, in particular the electric guitar. It is relevant both to live performance and to recording in providing increased tonal variety from electric guitars.

### BRIEF SUMMARY OF THE INVENTION

The Pole Position Sliding Pickup System allows an electric guitar player to get more tonal variety from his/her instrument than is currently possible by allowing the instrument's pickup to be easily positioned in numerous positions, and changed as often as desired. This is a complete change from the current system of fixed-position pickups which can only offer a set number of tonal options based on where the pickups are affixed to the guitar body.

### BRIEF DESCRIPTION OF THE SEVERAL VIEWS OF THE DRAWING(S)

FIG. 1 illustrates the parallel holes in the pickguard (1) that extend from the base of the neck to the bridge and enable the slider handle (3) to be pushed up and down on a fixed path, thereby moving the pickup (2) along the rails (5) and placing it in any desired position. FIG. 1 also illustrates that there is a need for only one volume control and one tone control (4) since there is only one pickup. FIG. 1 shows the slider handle (3) and the pickup (2) in the lowest position on the fixed path, by the bridge, where it would have the brightest sound (most treble).

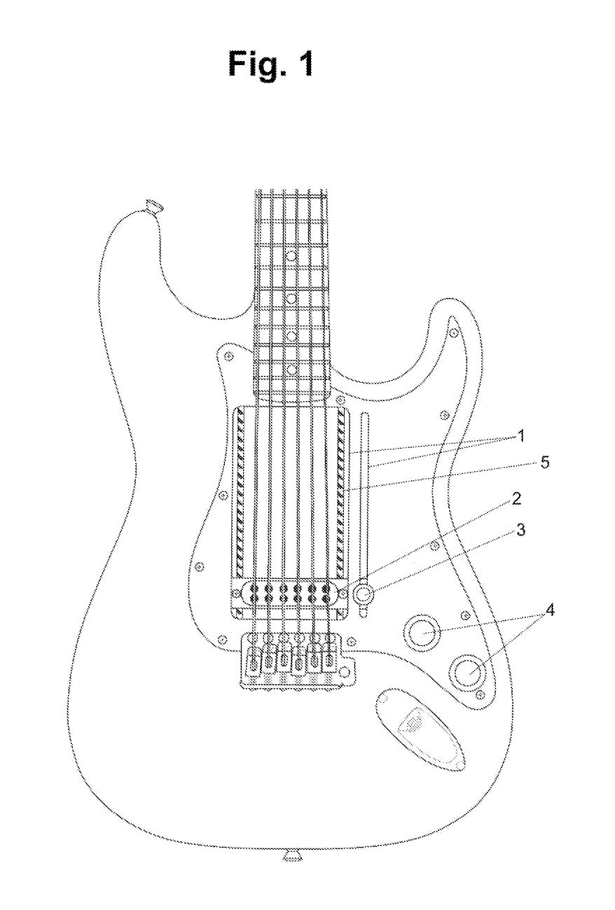

FIG. 2 shows the slider handle (3) and the pickup (2) having been pushed up to the highest position on the fixed path, by the base of the neck, where it would have the dullest sound (most bass).

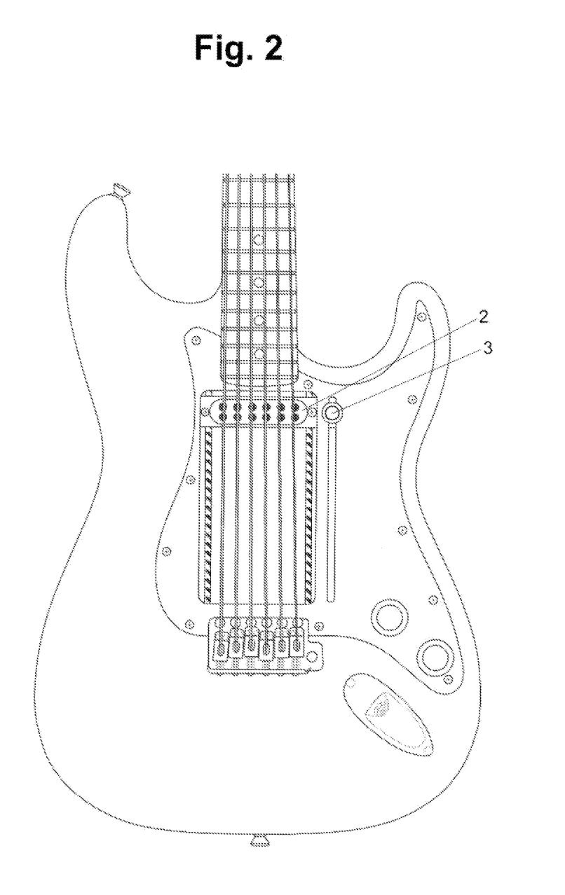

### DETAILED DESCRIPTION OF THE INVENTION

The placement of pickup on an electric guitar body (from only one pickup in the earliest electric guitar models to two or three pickups in later models) has always been as important to the sound of an electric guitar as other features, such as the wood it is made of, the method used to construct it, and even the type of strings used.

Pickup locations long ago became standard. In essence, a pickup placed close to the base of the neck will generate a duller tone, whereas a pickup placed closer to the bridge will create a brighter tone. Many electric guitar models place their pickup(s) in these areas in order to offer players two distinct sounds. Models that have a third pickup placed in between these two can still only offer the player a fraction of the available sounds that can be gotten from the space between the bridge and the base of the neck.

The Pole Position Sliding Pickup System is designed to allow electric guitar players quick, easy access to greater tonal variety by making the pickup movable to any desired position between the neck and the bridge rather than tying it to any single position, thereby limiting what it can do.

The body cavity created for the pickup would be somewhat larger than current cavities in order to make room for the rails that the pickup would “ride” on when the user slides it into the desired position.

The user would be able to slide the pickup using a single finger, even while continuing to play. Because the slider handle is conveniently placed where a player strums/picks the strings, it is more convenient than conventional pickup switches, which are generally placed at the far bottom or far top of an electric guitar.

1. The invention claimed is an electric guitar pickup positioning system consisting of a slider handle and a rail system which enables the guitar player to position a single pickup anywhere from the base of the neck to the bridge in order to get the most tonal variety from the instrument.
The invention claimed is an electric guitar pickup positioning system consisting of an enlarged body cavity which contains a system of rails or sliders which sit beneath the electric guitar's pickguard.
The invention claimed is an electric guitar pickup positioning system consisting of a single pickup which can generate a wide variety of tonal possibilities through repositioning as opposed to two or more stationary pickups.
